(19) United States
(12) Patent Application Publication
(10) Pub. No.: US 2009/0299978 A1
(43) Pub. Date: Dec. 3, 2009

(54) SYSTEMS AND METHODS FOR KEYWORD AND DYNAMIC URL SEARCH ENGINE OPTIMIZATION

(76) Inventors: Alexander Farfurnik, Bnei Brack (IL); Guangshuo Xu, Beijing (CN)

Correspondence Address: Jeremiah J. Baunach, 1700 Seventh Ave., Suite 2100, Seattle, WA, 98101, US

(21) Appl. No.: 12/472,387

(22) Filed: May 27, 2009

Related U.S. Application Data
(60) Provisional application No. 61/056,449, filed on May 28, 2008.

(51) Int. Cl. G06F 17/30

(52) U.S. Cl. 707/3; 707/E17.108

(57) ABSTRACT

A method implemented on one or more computer processors for search engine optimization may comprise automatically determining a relevancy of the keywords, automatically assigning an inverse document frequency (IDF) value to each keyword designated highly relevant, automatically defining relationships between keywords that are determined both highly user-relevant and highly database-relevant, and automatically ranking each keyword in the selected set based upon factors comprising frequency of appearance of each keyword within items in the database. Also, a method for automatically generating a Uniform Resource Locator (URL) from a previous URL may comprise automatically defining a position of a possible URL parameter in the URL and existence of the possible URL parameter in the URL using a number within the URL representing a position of said possible URL parameter and existence of said possible URL based on the previous URL, and automatically generating the URL containing the number. Web pages with the generated URL may then be automatically generated and optimized for search engines by displaying relevant items from the database and creating a link structure within the web pages according to keyword relationships and keyword relevancy to database items.

### CROSS REFERENCE TO RELATED APPLICATIONS

Priority is hereby claimed under 35 U.S.C. 119(e) to provisional U.S. patent application Ser. No. 61/056,449 entitled “Systems and Methods for Search Engine optimization”, filed May 28, 2008, the entirety of which is hereby incorporated by reference.

### BACKGROUND

Search engine optimization (SEO) is the process of increasing the amount of visitors to a web site by ranking high in the search results of a search engine. The higher a web site ranks in the results of a search, the greater the chance that that site will be visited by a user. It is common practice for Internet users to not click through pages and pages of search results, so where a site ranks in a search is essential for directing more traffic toward the site. SEO helps to ensure that a site is accessible to a search engine and improves the chances that the site will be found by the search engine. Keywords (words entered by users that the search engine uses to perform a search) associated with web sites, web pages and URLs (Uniform Resource Locators) of web pages are an important part of SEO. However, many web sites and pages do not make use of these keywords entered by their users in a very efficient and optimized manner to increase relevant traffic to the web site.

In this regard, there is a need for search engine optimization that overcomes shortcomings of the prior art.

### SUMMARY

This summary is provided to introduce a selection of concepts that are further described below in the Detailed Description. This summary is not intended to identify key features or essential features of the subject matter, nor is it intended to be used as an aid in determining the scope of the invention.

In consideration of the above-identified shortcomings of the art, keyword and dynamic URL

search engine optimization is provided. For several embodiments, a method implemented on one or more computer processors for search engine optimization may comprise automatically recording keywords used to search a database of items, automatically determining a relevancy of the keywords with respect to how many users use the keywords to search the database, automatically selecting a set of keywords based upon the determination of relevancy, automatically determining a relevancy of the selected set of keywords with respect to search results obtained using the selected set of keywords, automatically assigning an inverse document frequency (IDF) value to each keyword in the selected set, automatically defining relationships between keywords that are determined both highly user-relevant and highly database-relevant, thereby creating a network of related keywords, and automatically ranking each keyword in the selected set based upon factors comprising frequency of appearance of each keyword within items in the database.

Also, a method for automatically generating a Uniform Resource Locator (URL) from a previous URL may comprise automatically defining a position of a possible URL parameter in the URL and existence of the possible URL parameter in the URL using a number within the URL representing a position of said possible URL parameter and existence of said possible URL based on the previous URL, and automatically generating the URL containing the number.

Other advantages and features of the invention are described below.

### BRIEF DESCRIPTION OF THE DRAWINGS

Systems and methods for keyword and dynamic URL search engine optimization (SEO) are further described with reference to the accompanying drawings in which:

FIG. 1 is a block diagram representing an exemplary computing device suitable for use in conjunction with implementing systems and methods for keyword and dynamic URL search engine optimization; and

FIG. 2 illustrates an exemplary networked computing environment in which many computerized processes may be implemented to perform keyword and dynamic URL search engine optimization.

FIG. 3 is a flow chart illustrating an example process for search engine optimization involving automatically generating keywords lists and defining their relationships;

FIG. 4 is a flow chart illustrating an example process for search engine optimization showing a more detailed view of the process for defining keyword relationships of FIG. 3.

FIG. 5 is a flow chart illustrating an example process for search engine optimization involving applying keywords from the keyword lists of FIGS. 3 and 4 to particular items.

FIG. 6 is a flow chart illustrating an example process for search engine optimization involving Uniform Resource Locator (URL) creation for dynamic web pages; and

FIG. 7 is a flow chart illustrating an example process for search engine optimization involving parsing the Uniform Resource Locator (URL) created by the example process of FIG. 6 for dynamic web pages.

### DETAILED DESCRIPTION

Certain specific details are set forth in the following description and figures to provide a thorough understanding of various embodiments of the invention. Certain well-known details often associated with computing and software technology are not set forth in the following disclosure to avoid unnecessarily obscuring the various embodiments of the invention. Further, those of ordinary skill in the relevant art will understand that they can practice other embodiments of the invention without one or more of the details described below. Finally, while various methods are described with reference to steps and sequences in the following disclosure, the description as such is for providing a clear implementation of embodiments of the invention, and the steps and sequences of steps should not be taken as required to practice this invention.

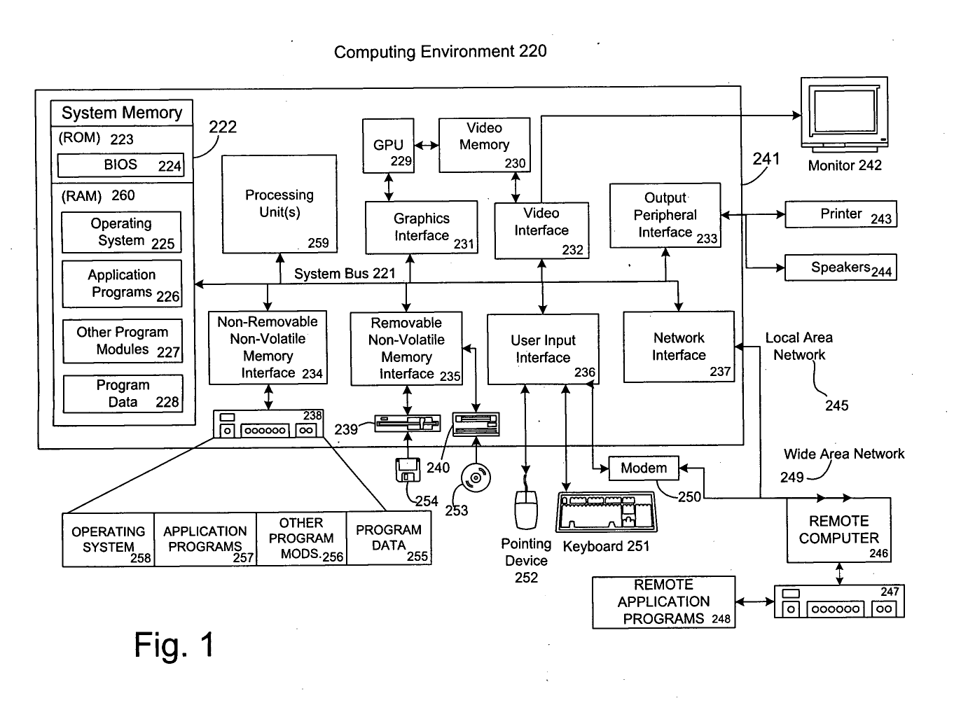

Referring next to FIG. 1, shown is a block diagram representing an exemplary computing environment suitable for use in conjunction with implementing the processes described below. For example, the computer-executable instructions that carry out the processes and methods for keyword and dynamic URL search engine optimization may reside and/or be executed in such a computing environment as shown in FIG. 1. The computing environment 220 is only one example of a suitable computing environment and is not intended to suggest any limitation as to the scope of use or functionality of the embodiments. Neither should the computing environment 220 be interpreted as having any dependency or requirement relating to any one or combination of components illustrated in the exemplary computing environment 220. For example a mobile device may also include one or more items such as those described below for use in conjunction with implementing the processes described below.

Aspects of the embodiments are operational with numerous other general purpose or special purpose computing environments or configurations. Examples of well known computing systems, environments, and/or configurations that may be suitable for use with the embodiments include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Aspects of the embodiments may be implemented in the general context of computer-executable instructions, such as program modules, being executed by a computer. Generally, program modules include routines, programs, objects, components, data structures, etc. that perform particular tasks or implement particular abstract data types. Aspects of the embodiments may also be practiced in distributed computing environments where tasks are performed by remote processing devices that are linked through a communications network. In a distributed computing environment, program modules may be located in both local and remote computer storage media including memory storage devices.

An exemplary system for implementing aspects of the embodiments includes a general purpose computing device in the form of a computer 241. Components of computer 241 may include, but are not limited to, a processing unit 259, a system memory 222, a graphics interface 231, a graphics processing unit (GPU) 229, video memory 230, video interface 232 and a system bus 221 that couples various system components including the system memory 222 to the processing unit 259. The system bus 221 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 241 typically includes a variety of computer readable media. Computer readable media can be any available media that can be accessed by computer 241 and include both volatile and nonvolatile media, removable and non-removable media. By way of example, and not limitation, computer readable media may comprise computer storage media and communication media. Computer storage media include both volatile and nonvolatile, removable and non-removable media implemented in any method or technology for storage of information such as computer readable instructions, data structures, program modules or other data. Computer storage media include, but are not limited to, random access memory (RAM), read-only memory (ROM), Electrically Erasable Programmable Read-Only Memory (EEPROM), flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 241. By way of example, and not limitation, communication media include wired media such as a wired network or direct-wired connection, and wireless media such as acoustic, radio frequency (RF), infrared and other wireless media. Combinations of the any of the above should also be included within the scope of computer readable media.

The system memory 222 includes computer storage media in the form of volatile and/or nonvolatile memory such as ROM 223 and RAM 260. A basic input/output system (BIOS) 224, containing the basic routines that help to transfer information between elements within computer 241, such as during start-up, is typically stored in ROM 223. RAM 260 typically contains data and/or program modules that are immediately accessible to and/or presently being operated on by processing unit 259. By way of example, and not limitation, FIG. 1 illustrates operating system 225, application programs 226, other program modules 227, and program data 228.

The computer 241 may also include other removable/non-removable, volatile/nonvolatile computer storage media. By way of example only, FIG. 1 illustrates a hard disk drive 238 that reads from or writes to non-removable, nonvolatile magnetic media, a magnetic disk drive 239 that reads from or writes to a removable, nonvolatile magnetic disk 254, and an optical disk drive 240 that reads from or writes to a removable, nonvolatile optical disk 253 such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 238 is typically connected to the system bus 221 through a non-removable memory interface such as interface 234, and magnetic disk drive 239 and optical disk drive 240 are typically connected to the system bus 221 by a removable memory interface, such as interface 235.

The drives and their associated computer storage media discussed above and illustrated in FIG. 1 provide storage of computer readable instructions, data structures, program modules and other data for the computer 241. In FIG. 1, for example, hard disk drive 238 is illustrated as storing operating system 258, application programs 257, other program modules 256, and program data 255. Note that these components can either be the same as or different from operating system 225, application programs 226, other program modules 227, and program data 228. Operating system 258, application programs 257, other program modules 256, and program data 255 are given different numbers here to illustrate that, at a minimum, they are different copies. A user may enter commands and information into the computer 241 through input devices such as a keyboard 251 and pointing device 252, commonly referred to as a mouse, trackball or touch pad. Other input devices (not shown) may include a microphone, joystick, game pad, satellite dish, scanner, or the like. These and other input devices are often connected to the processing unit 259 through a user input interface 236 that is coupled to the system bus 221, but may be connected by other interface and bus structures, such as a parallel port, game port or a universal serial bus (USB). A monitor 242 or other type of display device is also connected to the system bus 221 via an interface, such as a video interface 232. In addition to the monitor 242, computer 241 may also include other peripheral output devices such as speakers 244 and printer 243, which may be connected through an output peripheral interface 233.

The computer 241 may operate in a networked environment using logical connections to one or more remote computers, such as a remote computer 246. The remote computer 246 may be a personal computer, a server, a router, a network PC, a peer device or other common network node, and typically includes many or all of the elements described above relative to the computer 241, although only a memory storage device 247 has been illustrated in FIG. 1. The logical connections depicted in FIG. 1 include a local area network (LAN) 245 and a wide area network (WAN) 249, but may also include other networks. Such networking environments are commonplace in offices, enterprise-wide computer networks, intranets and the Internet.

When used in a LAN networking environment, the computer 241 is connected to the LAN 245 through a network interface or adapter 237. When used in a WAN networking environment, the computer 241 typically includes a modem 250 or other means for establishing communications over the WAN 249, such as the Internet. The modem 250, which may be internal or external, may be connected to the system bus 221 via the user input interface 236, or other appropriate mechanism. In a networked environment, program modules depicted relative to the computer 241, or portions thereof, may be stored in the remote memory storage device 247. By way of example, and not limitation, FIG. 1 illustrates remote application programs 248 as residing on the remote memory storage device 247. It will be appreciated that the network connections shown are exemplary and other means of establishing a communications link between the computers may be used.

It should be understood that the various techniques described herein may be implemented in connection with hardware or software or, where appropriate, with a combination of both. As used herein a “system” or “subsystem” may comprise one or more of, or any combination of, the following: mechanical devices, hardware, components of hardware, circuits, circuitry, logic design, logical components, software, software modules, components of software or software modules, software procedures, software instructions, software routines, software objects, software functions, software classes, software programs, files containing software, etc., to perform the intended function of the system or subsystem. Thus, the methods and apparatus of the embodiments, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the embodiments. In the case of program code execution on programmable computers, the computing device generally includes a processor, a storage medium readable by the processor (including volatile and non-volatile memory and/or storage elements), at least one input device, and at least one output device. One or more programs that may implement or utilize the processes described in connection with the embodiments, e.g., through the use of an application programming interface (API), reusable controls, or the like. Such programs are preferably implemented in a high level procedural or object-oriented programming language to communicate with a computer system. However, the program(s) can be implemented in assembly or machine language, if desired. In any case, the language may be a compiled or interpreted language, and combined with hardware implementations.

Although exemplary embodiments may refer to utilizing aspects of the embodiments in the context of one or more stand-alone computer systems, the embodiments are not so limited, but rather may be implemented in connection with any computing environment, such as a network or distributed computing environment. Still further, aspects of the embodiments may be implemented in or across a plurality of processing chips or devices, and storage may similarly be effected across a plurality of devices. Such devices might include personal computers, network servers, handheld devices, supercomputers, or computers integrated into other systems such as automobiles and airplanes.

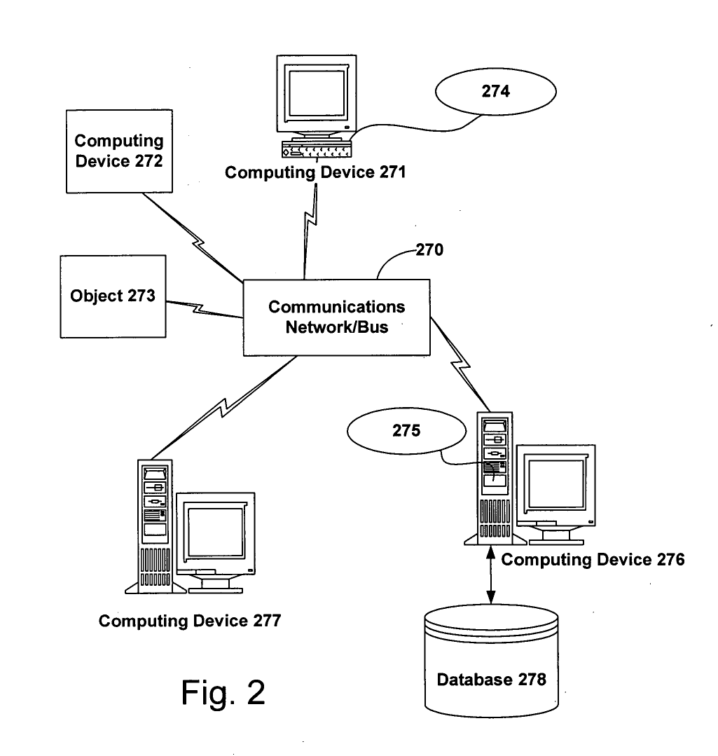

Referring next to FIG. 2, shown is an exemplary networked computing environment in which many computerized processes may be implemented to perform the processes described below. For example, distributed or parallel computing may be part of such a networked environment with various clients on the network of FIG. 2 using and/or implementing systems and methods for keyword and dynamic URL search engine optimization. One of ordinary skill in the art can appreciate that networks can connect any computer or other client or server device, or in a distributed computing environment. In this regard, any computer system or environment having any number of processing, memory, or storage units, and any number of applications and processes occurring simultaneously is considered suitable for use in connection with the systems and methods provided.

Distributed computing provides sharing of computer resources and services by exchange between computing devices and systems. These resources and services include the exchange of information, cache storage and disk storage for files. Distributed computing takes advantage of network connectivity, allowing clients to leverage their collective power to benefit the entire enterprise. In this regard, a variety of devices may have applications, objects or resources that may implicate the processes described herein.

FIG. 2 provides a schematic diagram of an exemplary networked or distributed computing environment. The environment comprises computing devices 271, 272, 276, and 277 as well as objects 273, 274, and 275, and database 278. Each of these entities 271, 272, 273, 274, 275, 276, 277 and 278 may comprise or make use of programs, methods, data stores, programmable logic, etc. The entities 271, 272, 273, 274, 275, 276, 277 and 278 may span portions of the same or different devices such as PDAs, audio/video devices, MP3 players, personal computers, etc. Each entity 271, 272, 273, 274, 275, 276, 277 and 278 can communicate with another entity 271, 272, 273, 274, 275, 276, 277 and 278 by way of the communications network 270. In this regard, any entity may be responsible for the maintenance and updating of a database 278 or other storage element.

This network 270 may itself comprise other computing entities that provide services to the system of FIG. 2, and may itself represent multiple interconnected networks. In accordance with aspects of the embodiments, each entity 271, 272, 273, 274, 275, 276, 277 and 278 may contain discrete functional program modules that might make use of an API, or other object, software, firmware and/or hardware, to request services of one or more of the other entities 271, 272, 273, 274, 275, 276, 277 and 278.

It can also be appreciated that an object, such as 275, may be hosted on another computing device 276. Thus, although the physical environment depicted may show the connected devices as computers, such illustration is merely exemplary and the physical environment may alternatively be depicted or described comprising various digital devices such as PDAs, televisions, MP3 players, etc., software objects such as interfaces, COM objects and the like.

There are a variety of systems, components, and network configurations that support distributed computing environments. For example, computing systems may be connected together by wired or wireless systems, by local networks or widely distributed networks. Currently, many networks are coupled to the Internet, which provides an infrastructure for widely distributed computing and encompasses many different networks. Any such infrastructures, whether coupled to the Internet or not, may be used in conjunction with the systems and methods provided.

A network infrastructure may enable a host of network topologies such as client/server, peer-to-peer, or hybrid architectures. The “client” is a member of a class or group that uses the services of another class or group to which it is not related. In computing, a client is a process, i.e., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g., a server. In the example of FIG. 2, any entity 271, 272, 273, 274, 275, 276, 277 and 278 can be considered a client, a server, or both, depending on the circumstances.

A server is typically, though not necessarily, a remote computer system accessible over a remote or local network, such as the Internet. The client process may be active in a first computer system, and the server process may be active in a second computer system, communicating with one another over a communications medium, thus providing distributed functionality and allowing multiple clients to take advantage of the information-gathering capabilities of the server. Any software objects may be distributed across multiple computing devices or objects.

Client(s) and server(s) communicate with one another utilizing the functionality provided by protocol layer(s). For example, HyperText Transfer Protocol (HTTP) is a common protocol that is used in conjunction with the World Wide Web (WWW), or “the Web.” Typically, a computer network address such as an Internet Protocol (IP) address or other reference such as a Universal Resource Locator (URL) can be used to identify the server or client computers to each other. The network address can be referred to as a URL address. Communication can be provided over a communications medium, e.g., client(s) and server(s) may be coupled to one another via TCP/IP connection(s) for high-capacity communication.

In light of the diverse computing environments that may be built according to the general framework provided in FIG. 2 and the further diversification that can occur in computing in a network environment such as that of FIG. 2, the systems and methods provided herein cannot be construed as limited in any way to a particular computing architecture. Instead, the embodiments should be construed in breadth and scope in accordance with the appended claims.

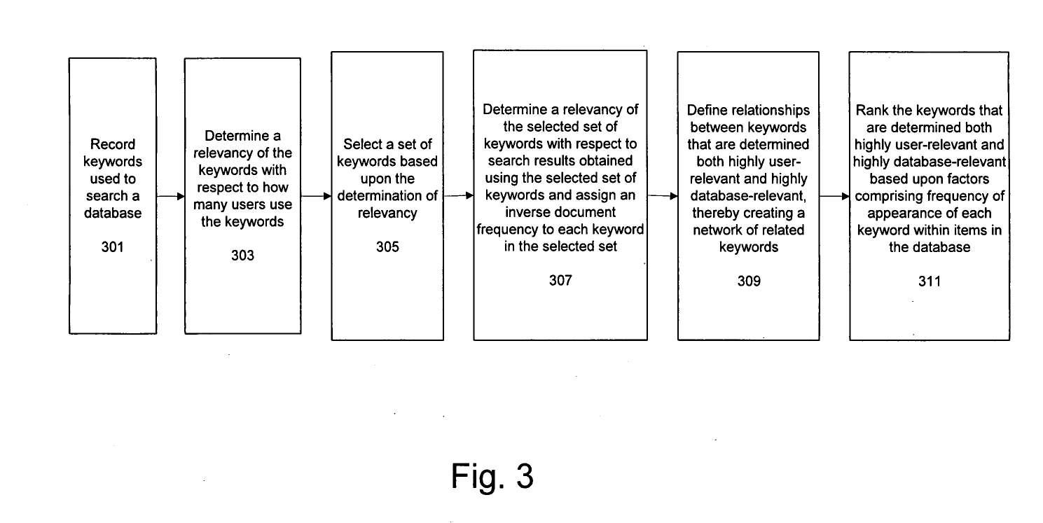

Referring next to FIG. 3, shown is a flow chart illustrating an example process for search engine optimization involving automatically generating keywords lists and defining their relationships. This process and a system implementing said process is referred to herein as The Smarter Keywords System™. The Smarter Keywords System™ is a system which is based on user behavior and a large-scale database of items (i.e., item database). These items may comprise of any digitally stored pieces of data that are able to be searched using the database. The system's purpose is to automatically generate keywords lists and define their relationships. The keywords are ranked by the most relevant keywords to the database and to the users searching the database.

An example process according to the Smarter Keywords System™ is provided below and applies to an available up-to-date database that can serve a representative share of the whole scope.

While users are sending search queries to the database (using any interface) the system may automatically record 301 the searched keywords. Next, a relevancy of the keywords with respect to how many users use the keywords is automatically determined 303. For example, periodically, the system analyzes all new user-searched keywords. Keywords get high user-relevancy if they were searched by a large enough number of users during the last time interval. The particular amount of users needed for a high user-relevancy designation or score for a particular keyword may vary, for example, depending on the particular database being searched and how many users on average search the database. The specific time interval used between each analysis can also vary, but generally, the shorter the period of time used, the more accurate the overall search engine optimization process may be.

A set of the keywords that received a high enough user-relevancy score during the process above are automatically selected 305 and analyzed for database-relevancy. A relevancy of the selected set of keywords with respect to search results obtained using the selected set of keywords is automatically determined 307 and an inverse document frequency (IDF) is assigned to each keyword in the selected set. The IDF is a weight factor that is defined as the logarithm of the number of items divided by the number of items that contain that keyword. For example, the database may be automatically searched using the set of keywords as generated above and the keywords with a large enough number of results are designated as database-relevant. The number of results that large enough may be user-defined according to the particular characteristics of the keywords and database used. The process then automatically attaches an IDF (inverse document frequency) to each keyword. Finally, keywords that are designated both highly user-relevant and highly database-relevant are automatically determined 307 as relevant and inserted into the system. This insertion in to the system may be performed by the highly user-relevant and highly database-relevant keywords being stored in a keywords database table with the keyword's name, IDF and other parameters.

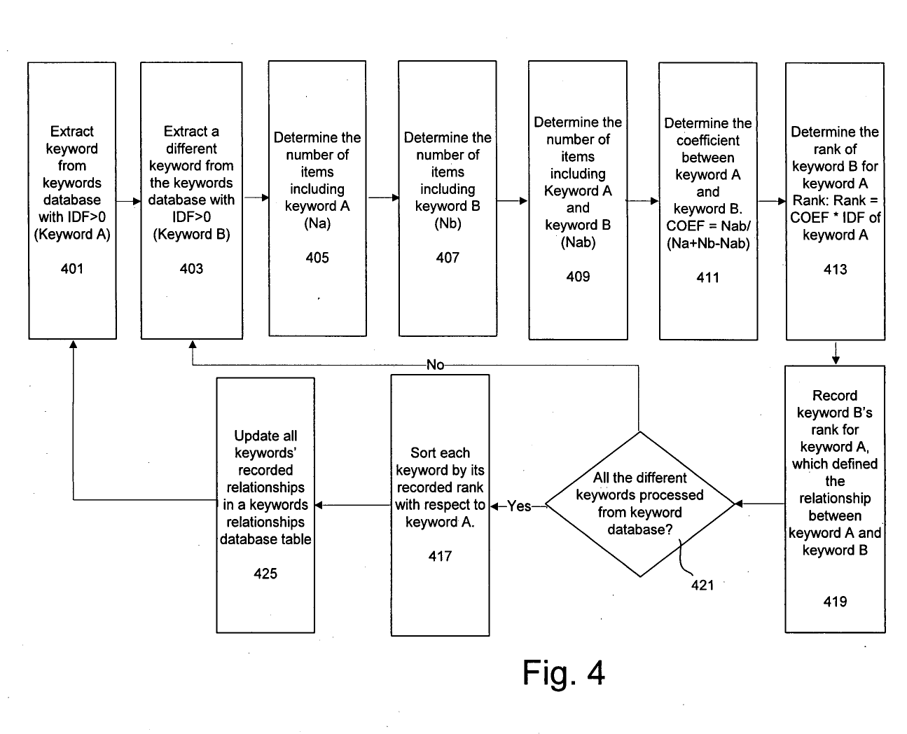

Next, relationships are defined 309 between the keywords in the keywords database (i.e., those that are determined both highly user-relevant and highly database-relevant), thereby creating a network of related keywords. Also, the keywords that are determined both highly user-relevant and highly database-relevant are ranked 311 based upon factors comprising frequency of appearance of each keyword within items in the database. The process for defining these keyword relationships and associated ranking of these keywords is described in more detail with reference to FIG. 4 below.

Referring next to FIG. 4, shown is a flow chart illustrating an example process for search engine optimization showing a more detailed view of the process for defining keyword relationships of FIG. 3. The first keyword with an IDF>0 is automatically extracted from the keywords database 401 (which for illustrative purposes will be designated herein as keyword A). Then, the next keyword in the keywords database with an IDF>0 is automatically extracted 403 (which for illustrative purposes will be designated herein as keyword B). Then the number of items in the item database including keyword A is automatically determined (which for illustrative purposes will be designated herein as Na). Then the number of items in the item database including keyword B is automatically determined 405 (which for illustrative purposes will be designated herein as Nb). The number of items in the item database including both keyword A and keyword B is then automatically determined 405 (which for illustrative purposes will be designated herein as Nab).

Using the number of items in the item database including both keyword A and keyword B (Nab), a coefficient between keyword A and keyword B (which for illustrative purposes will be designated herein as COEF) is automatically determined 411 according to the following formula: COEF=Nab/(Na+Nb−Nab). Using the coefficient between keyword A and keyword B, the rank of keyword B for keyword A is automatically determined 413 according to the following formula: Rank=COEF*IDF of keyword A. Next, keyword B's rank for keyword A (which defined the relationship between keyword A and keyword B) is automatically recorded 419.

The process above may then repeat for all the keywords in the keywords database with respect to each other. For example, it is then automatically determined 421 whether all the different keywords from keyword A have been processed from the keywords database. If not, then the process continues automatically extracting 403 the next keyword in the keywords database different from keyword A and continues in the process treating it as keyword B in the calculations and determinations of keywords relationships above. If all the keywords different from keyword A have been processed, it is then each keyword is sorted 417 by its recorded rank with respect to keyword A. The processed keywords' recorded relationships are automatically updated 425 in a keywords relationships database table according to the newly defined relationships. Then the process may continue automatically extracting 401 another keyword and continues in the process treating it as keyword A in the calculations and determinations of keywords relationships above. The process repeats as above continuously extracting keywords from the keywords database and defining their relationships with respect to each other.

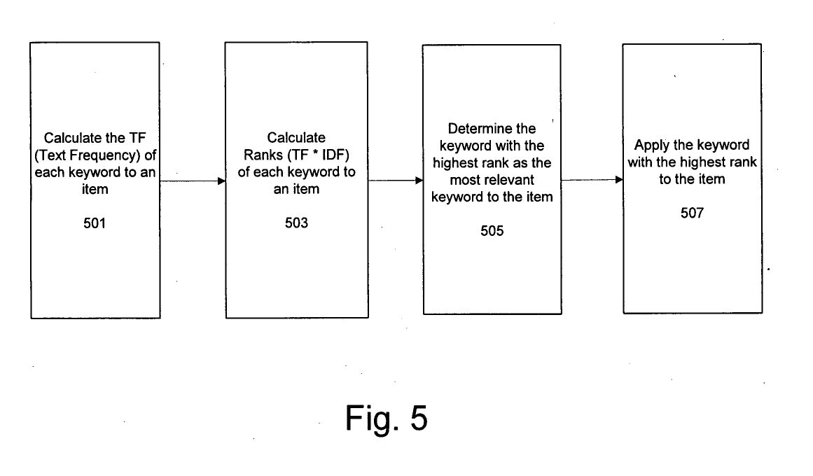

Referring next to FIG. 5, shown is a flow chart illustrating an example process for search engine optimization involving applying keywords from the keyword lists of FIGS. 3 and 4 to particular items. After all the keywords' relationships are automatically updated 425 in a keywords relationships database table, then the most relevant keywords as determined by the rankings in the defining of the keyword relationships above may be applied to items in the items database. First, the Text Frequency (TF) of each keyword to an item in the item database is automatically calculated 501. The TF may be defined generally as the frequency that the keyword appears within the text of the item. Then the rank of each keyword to an item is automatically calculated 503 according to the following formula (TF*IDF). Next, the keyword with the highest rank is automatically determined 505 as the most relevant keyword to the item. Then, the keyword or keywords with the highest rank may then be automatically applied to or otherwise associated with 507 the item (such as by adding relevant links, keywords and text on related webpages containing said keywords), thus increasing search engine performance and optimization.

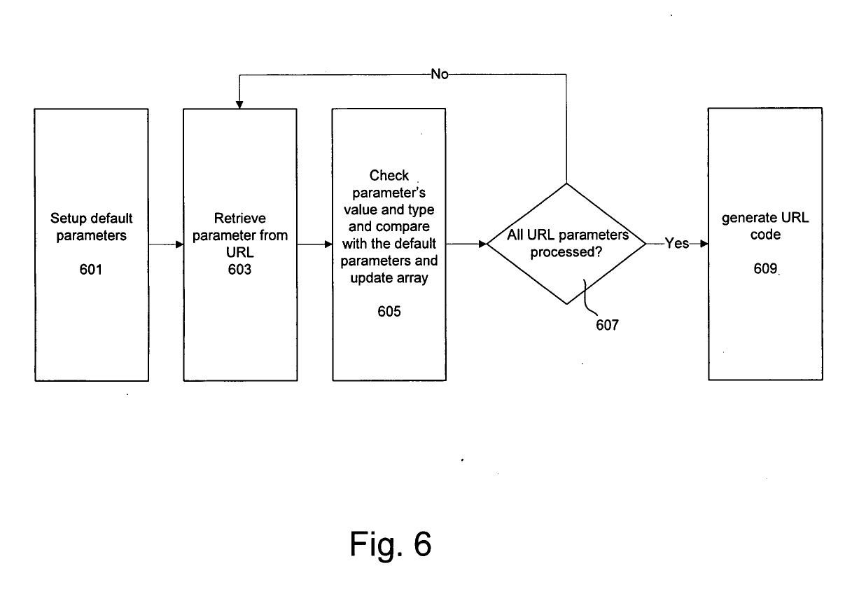

Referring next to FIG. 6, shown is a flow chart illustrating an example process for search engine optimization involving Uniform Resource Locator (URL) creation for dynamic web pages. This process and a system implementing said process is referred to as The Magic URL™. The Magic URL™ is a general search engine optimization (SEO) solution that is focused on URL optimization. The purpose is to automatically generate SEO friendly URLs for dynamic web pages.

A dynamic web page is created in real time, often with reference to a database query, in response to a user request. In programming dynamic web pages, web application developers commonly use URL parameters to pass values to variables within applications. Typical uses of URL parameters include personalizing websites based on a user's preferences. For example, one could pass search terms to SQL variables in a web application to generate search results. The automatically generated SEO friendly URL described herein is generated on provided parameters and is referred to herein as the The Magic URL™ (i.e., URL code).

The first step is to set up and define 601 possible parameters that will be used in the dynamic web pages for which search engine optimization is sought. These parameters include name and type, for example. In the present example, the parameters can be defined as having four types:

Boolean: The value should be 0 or 1;
String: Dynamic length string;
Enumerate: 1 character variable;
Long Integer: Integer numeric string;

All the URL parameters are defined into an array with their respective names and values. The core part of the Magic URL™ (i.e. URL code) is the “magic number” (i.e., URL code number) which defines the parameters' position and existence in the URL. The “magic number” (URL code number) is a binary number and automatically converted into a 32-based number (or other suitable encoding), for example. The order of the URL code number digits is generated by the order of predefined URL parameters. If a given parameter has value then the given position of the digit will be filled as 1, otherwise it will be 0.

The parameters of type String are separated by slash (another SEO friendly character such as “_” or “+”) at the beginning of the Magic URL™ (URL code). After the String parameters is the “magic number” (URL code number). The parameters whose types are Boolean or Enumerate are connected and separated with the “magic number” (URL code number) by a dash (another SEO friendly character such as “_” or “+”). The Long Integer parameters are each separated by a dash and appear at the end of the URL.

To create the URL code or “magic number” (URL code number), the first step is to automatically retrieve 603 the first parameter of the URL. Then parameter's value and type are then automatically checked and compared with the defined default parameters and the array is updated 605 according to the rules above. It is then automatically determined 607 whether all the parameters of the URL have been processed. If all the parameters of the URL have been processed, then the Magic URL™ (i.e. URL code) is automatically generated according to the updated array and rules above. Below is an example of a generated URL with a Magic URL™ (i.e. URL code) generated according to the above process. The chart below shows how the “magic number” (URL code number) value is created based on which of the predefined parameters exists in the URL. The system supports any amount of additional variables which is only limited by the size of the array used. Note that when new parameters are added to the predefined parameters, all the previous generated URLs stay the same as before, which is a big advantage for SEO.

### EXAMPLE

http ://cd.jipingmi.com/ZuFang/ChengDu/JinJiang/YanShiKou/3c04-88-645/

### Explanation:

| Magic | 3c04 (in this example base 32) = 11 01100 00000 00100 in binary | | | | | | | | | | | | | | | | |
|---|---|---|---|---|---|---|---|---|---|---|---|---|---|---|---|---|---|
| Number | | | | | | | | | | | | | | | | | |
| Binary | 1 | 1 | 0 | 1 | 1 | 0 | 0 | 0 | 0 | 0 | 0 | 0 | 0 | 0 | 1 | 0 | 0 |
| Value | | | | | | | | | | | | | | | | | |
| Variable | city_id | district_id | | city_name | district_name | | | | | | | | | | keyword | | |
| URL | 88 | 645 | | Chengdu | JinJiang | | | | | | | | | | YanShiKou | | |
| Values | | | | | | | | | | | | | | | | | |

| | |
|---|---|
| Magic | http://cd.jipingmi.com/ZuFang/ChengDu/JinJiang/YanShiKou/3c04-88-645/ |
| URL | |
| Normal | http://cd.jipingmi.com/search.php?city_id=88&district_id=645&city_name=Chengdu&district_name=JinJian |
| URL | g&keyword=YanShiKou |

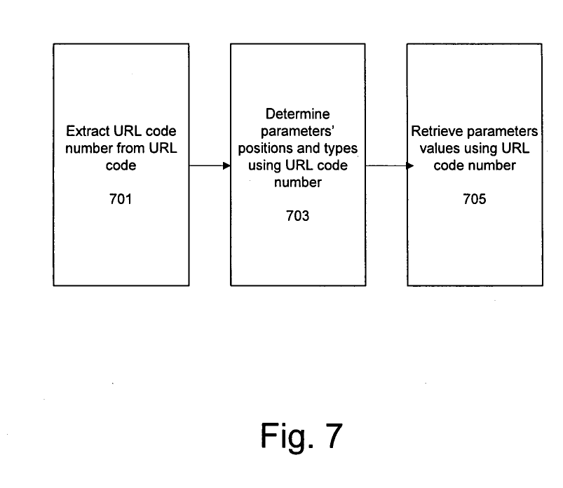

Referring next to FIG. 7, shown is a flow chart illustrating an example process for search engine optimization involving parsing the Uniform Resource Locator (URL) created by the example process of FIG. 6 for dynamic web pages. First, the “magic number” (URL code number) is automatically extracted 701 from the generated URL the formatting rules described above as a guide to navigate the generated URL. Next, the parameters' positions and types are automatically determined 703 using the extracted URL code number which defines the number of parameters and the parameters' positions in the array as described above. Then, the parameters' values are automatically retrieved from the array using the determined parameter positions and types. Once the parameters are retrieved then the dynamic web page may be generated according to the retrieved parameters.

According to the keyword and dynamic URL search engine optimization processes described above, web pages may be generated based on searches of the database that are optimized for search engines. For example, every time a keyword enters the keywords database according to step 311 of FIG. 3, at least 2^{x} new web pages may be potentially created (wherein x=the number of default parameters set up in step 601 of FIG. 6.) and these web pages will be given the URL address as described in step 609 of FIG. 6. Each of these web pages above may be automatically optimized for search engines for the keyword inserted into the keywords database. For example, the web pages created may contain highly relevant information which is the search results from database items according to the parameters of the Magic URL™. Also, for each of the items above, the web page may include at least one link according to keyword relevancy as described in step 507 of FIG. 5. Each page can potentially include at least 2^{x} links that are very relevant according to keyword relationships as updated in the keywords relationships database table in step 425 of FIG. 4.

It is noted that the foregoing examples have been provided merely for the purpose of explanation and are in no way to be construed as limiting of the present invention. While the invention has been described with reference to various embodiments, it is understood that the words which have been used herein are words of description and illustration, rather than words of limitations. Further, although the invention has been described herein with reference to particular means, materials and embodiments, the invention is not intended to be limited to the particulars disclosed herein; rather, the invention extends to all functionally equivalent structures, methods and uses. Those skilled in the art, having the benefit of the teachings of this specification, may effect numerous modifications thereto and changes may be made without departing from the scope and spirit of the invention in its aspects.

What is claimed:

1. A method implemented on one or more computer processors for search engine optimization comprising:
automatically recording keywords used to search a database of items;
automatically determining a relevancy of the keywords with respect to how many users use the keywords to search the database;
automatically selecting a set of keywords based upon the determination of relevancy;
automatically determining a relevancy of the selected set of keywords with respect to search results of items obtained using the selected set of keywords;
automatically assigning an inverse document frequency (IDF) value to each keyword in the selected set;
automatically defining relationships between keywords that are determined both highly user-relevant and highly database-relevant, thereby creating a network of related keywords; and
automatically ranking each keyword in the selected set based upon factors comprising frequency of appearance of each keyword within items in the database.

2. The method of claim 1 wherein the automatically ranking each keyword in the selected set comprises:
calculating the text frequency (TF) of each keyword in the selected set to at least one item in the database; and
calculating a rank of each keyword in the selected set with respect to the at least one item according to the following formula: rank=TF*IDF of keyword.

3. The method of claim 1 further comprising associating keywords in the selected set to items in the database based upon the keyword's ranking and defined relationships wherein a keyword with the highest rank with respect to a particular item is designated as most relevant to the particular item.

4. The method of claim 3 wherein the automatically determining a relevancy of the keywords with respect to how many users use the keywords to search the database comprises:
periodically automatically analyzing all new user-searched keywords; and
automatically designating as highly user-relevant a subset of the new user-searched keywords based on a number of times the subset of new user-searched keywords are being used over a specified amount.

5 . The method of claim 3 wherein the automatically determining a relevancy of the selected set of keywords with respect to search results obtained using the selected set of keywords comprises:
automatically searching the database using the selected set of keywords thereby producing search results; and
automatically designating a subset of the selected set of keywords as highly database-relevant based on a number the search results containing the subset of keywords being over a specified amount.

6. The method of claim 3 wherein the automatically defining relationships between keywords comprises:
storing in a keywords database keywords that are determined both highly user-relevant and highly database-relevant based on the automatically determining the relevancy of the keywords with respect to how many users use the keywords to search the database, the automatically selecting a set of keywords based upon the determination of relevancy, and the automatically determining a relevancy of the selected set of keywords with respect to search results obtained using the selected set of keywords;
for each pair of keywords in the keywords database with an IDF assigned greater than zero, automatically determining a number of items in the database containing a first keyword in the pair of keywords (designated herein as Na), automatically determining a number of items in the database containing a second keyword in the keyword pair (designated herein as Nb), automatically determining a number of items in the database containing both keywords in the pair of keywords (designated herein as Nab), automatically calculating a coefficient (designated herein COEF) of the pair of keywords according to the following formula: COEF=Nab/(Na+Nb−Nab), automatically assigning a rank of the second keyword for the first keyword in the pair of keywords according to the following formula: rank=COEF*IDF of keyword, and automatically recording the assigned rank of the second keyword for the first keyword in the pair thereby defining a relationship between the first keyword and second keyword; and
automatically sorting each keyword in the keywords database by the said recorded assigned rank of the keyword with respect to each other keyword in the keywords database;

7. The method of claim 3, further comprising automatically generating at least one web page as a result of at least one of the keywords being used to search the database and based on the previous associating of the keywords in the selected set to items in the database.

8. The method of claim 7, further comprising automatically generating a Uniform Resource Locator (URL) from a previous URL of the generated web page, said previous URL having at least one parameter with a value of the at least one of the keywords being used to search the database, said automatically generated URL generated by:
automatically defining a position of a possible URL parameter and existence of the possible URL parameter in the generated URL using a number within the generated URL representing a position of said possible URL parameter and existence of said possible URL parameter based on the previous URL; and
automatically generating a URL containing the number as the generated URL.

9. The method of claim 8, further comprising:
automatically optimizing for search engines the at least one web page generated by automatically displaying in the at least one web page at least one relevant item from the database as determined by the at least one of the keywords being used to search the database and the previous associating of the keywords in the selected set to items in the database; and
automatically optimizing for search engines the at least one web page generated by displaying at least one link within the at least one web page based on relationships of the at least one of the keywords being used to search the database as defined in the defined keyword relationships.

10. A method for automatically generating a Uniform Resource Locator (URL) from a previous URL comprising:
automatically defining a position of a possible URL parameter and existence of the possible URL parameter in the URL using a number within the URL representing a position of said possible URL parameter and existence of said possible URL parameter based on the previous URL; and
automatically generating the URL containing the number.

11. The method of claim 10 wherein an order of digits of the number is generated by an order of predefined URL parameters.

12. The method of claim 11 wherein the automatically defining a position of a possible URL parameter in the URL and existence of the possible URL parameter in the URL comprises:
automatically correlating each digit of a binary number with a position of a possible parameter within a previous URL; and
automatically assigning a digit of the number a value of 1 if a parameter exists within the previous URL corresponding to a parameter position correlated to the digit; and
automatically assigning a digit of the number a value of 0 if a parameter does not exist within the previous URL corresponding to a parameter position correlated to the digit.

13. The method of claim 12 further comprising automatically converting the number into a base-32 number.

14. The method of clam 13 further comprising adding an additional predefined URL parameter to the generated URL, said adding an additional predefined URL parameter comprising adding the additional predefined URL parameter to the predefined URL parameters by correlating a binary digit to the left of the binary number to the additional predefined parameter, thereby allowing previous URLs generated using the predefined URL parameters to remain the same.

15. The method of claim 10 further comprising automatically generating the URL containing the number, wherein the URL is formatted such that the number in the URL is followed by URL parameters whose types are Boolean or are one-character in length are connected and separated with the number by a dash.

16. The method of claim 15 further comprising automatically generating the URL containing the number wherein the URL is formatted such that the number in the URL is preceded by parameters whose type is String and are separated by slashes.

17. The method of claim 10 further comprising automatically parsing the generated URL according to the order of digits of the number being generated by an order of predefined URL parameters.

18. A system implemented on one or more computer processors for search engine optimization comprising:
means for automatically recording keywords used to search a database of items;
means for automatically determining a relevancy of the keywords with respect to how many users use the keywords to search the database;
means for automatically selecting a set of keywords based upon the determination of relevancy;
means for automatically determining a relevancy of the selected set of keywords with respect to search results of items obtained using the selected set of keywords;
means for automatically assigning an inverse document frequency (IDF) value to each keyword in the selected set;
means for automatically defining relationships between keywords that are determined both highly user-relevant and highly database-relevant, thereby creating a network of related keywords; and
means for automatically ranking each keyword in the selected set based upon factors comprising frequency of appearance of each keyword within items in the database.

19. The system of claim 18 wherein the means for automatically ranking each keyword in the selected set comprise:
means for calculating the text frequency (TF) of each keyword in the selected set to at least one item in the database; and
means for calculating a rank of each keyword in the selected set with respect to the at least one item according to the following formula: rank=TF*IDF of keyword.

20. The system of claim 18 further comprising means for associating keywords in the selected set to items in the database based upon the keyword's ranking and defined relationships wherein a keyword with the highest rank with respect to a particular item is designated as most relevant to the particular item.

21. The system of claim 20 wherein the means for automatically determining a relevancy of the keywords with respect to how many users use the keywords to search the database comprise:
means for periodically automatically analyzing all new user-searched keywords; and
means for automatically designating as highly user-relevant a subset of the new user-searched keywords based on a number of times the subset of new user-searched keywords are being used over a specified amount.

22. The system of claim 20 wherein the means for automatically determining a relevancy of the selected set of keywords with respect to search results obtained using the selected set of keywords comprise:
means for automatically searching the database using the selected set of keywords thereby producing search results; and
means for automatically designating a subset of the selected set of keywords as highly database-relevant based on a number the search results containing the subset of keywords being over a specified amount.

23. The system of claim 20 wherein the means for automatically defining relationships between keywords comprise:
means for storing in a keywords database keywords that are determined both highly user-relevant and highly database-relevant based on the automatically determining the relevancy of the keywords with respect to how many users use the keywords to search the database, the automatically selecting a set of keywords based upon the determination of relevancy, and the automatically determining a relevancy of the selected set of keywords with respect to search results obtained using the selected set of keywords;
means for, for each pair of keywords in the keywords database with an IDF assigned greater than zero, automatically determining a number of items in the database containing a first keyword in the pair of keywords (designated herein as Na), automatically determining a number of items in the database containing a second keyword in the keyword pair (designated herein as Nb), automatically determining a number of items in the database containing both keywords in the pair of keywords (designated herein as Nab), automatically calculating a coefficient (designated herein COEF) of the pair of keywords according to the following formula: COEF=Nab/(Na+Nb−Nab), automatically assigning a rank of the second keyword for the first keyword in the pair of keywords according to the following formula: rank=COEF*IDF of keyword, and automatically recording the assigned rank of the second keyword for the first keyword in the pair thereby defining a relationship between the first keyword and second keyword; and
means for automatically sorting each keyword in the keywords database by the said recorded assigned rank of the keyword with respect to each other keyword in the keywords database;

24. The system of claim 20, further comprising means for automatically generating at least one web page as a result of at least one of the keywords being used to search the database and based on the previous associating of the keywords in the selected set to items in the database.

25. The system of claim 24, further comprising means for automatically generating a Uniform Resource Locator (URL) from a previous URL of the generated web page, said previous URL having at least one parameter with a value of the at least one of the keywords being used to search the database, said automatically generated URL generated by:
means for automatically defining a position of a possible URL parameter and existence of the possible URL parameter in the generated URL using a number within the generated URL representing a position of said possible URL parameter and existence of said possible URL parameter based on the previous URL; and
means for automatically generating a URL containing the number as the generated URL.

26. The system of claim 25 further comprising:
means for automatically optimizing for search engines the at least one web page generated by automatically displaying in the at least one web page at least one relevant item from the database as determined by the at least one of the keywords being used to search the database and the previous associating of the keywords in the selected set to items in the database; and
means for automatically optimizing for search engines the at least one web page generated by displaying at least one link within the at least one web page based on relationships of the at least one of the keywords being used to search the database as defined in the defined keyword relationships.

27. A system for automatically generating a Uniform Resource Locator (URL) from a previous URL comprising:
means for automatically defining a position of a possible URL parameter and existence of the possible URL parameter in the URL using a number within the URL representing a position of said possible URL parameter and existence of said possible URL parameter based on the previous URL; and
means for automatically generating the URL containing the number.

28. The system of claim 27 wherein an order of digits of the number is generated by an order of predefined URL parameters.

29. The system of claim 28 wherein the means for automatically defining a position of a possible URL parameter in the URL and existence of the possible URL parameter in the URL comprise:
means for automatically correlating each digit of a binary number with a position of a possible parameter within a previous URL; and
means for automatically assigning a digit of the number a value of 1 if a parameter exists within the previous URL corresponding to a parameter position correlated to the digit; and
means for automatically assigning a digit of the number a value of 0 if a parameter does not exist within the previous URL corresponding to a parameter position correlated to the digit.

30. The system of claim 29 further comprising means for automatically converting the number into a base-32 number.

31. The system of clam 30 further comprising means for adding an additional predefined URL parameter to the generated URL, said adding an additional predefined URL parameter comprising adding the additional predefined URL parameter to the predefined URL parameters by correlating a binary digit to the left of the binary number to the additional predefined parameter, thereby allowing previous URLs generated using the predefined URL parameters to remain the same.

32. The system of claim 27 further wherein the URL is formatted such that the number in the URL is followed by URL parameters whose types are Boolean or are one-character in length are connected and separated with the number by a dash.

33. The system of claim 32 wherein the URL is formatted such that the number in the URL is preceded by parameters whose type is String and are separated by slashes.

34. The system of claim 27 further comprising means for automatically parsing the generated URL according to the order of digits of the number being generated by an order of predefined URL parameters.

35. A computer readable medium having computer executable instructions thereon for:
automatically recording keywords used to search a database of items;
automatically determining a relevancy of the keywords with respect to how many users use the keywords to search the database;
automatically selecting a set of keywords based upon the determination of relevancy;
automatically determining a relevancy of the selected set of keywords with respect to search results of items obtained using the selected set of keywords;
automatically assigning an inverse document frequency (IDF) value to each keyword in the selected set;
automatically defining relationships between keywords that are determined both highly user-relevant and highly database-relevant, thereby creating a network of related keywords; and
automatically ranking each keyword in the selected set based upon factors comprising frequency of appearance of each keyword within items in the database.

36. The computer readable medium of claim 35 wherein the computer executable instructions thereon for automatically ranking each keyword in the selected set comprise computer executable instructions for:
calculating the text frequency (TF) of each keyword in the selected set to at least one item in the database; and
calculating a rank of each keyword in the selected set with respect to the at least one item according to the following formula: rank=TF*IDF of keyword.

37. The computer readable medium of claim 35 further comprising computer executable instructions thereon for associating keywords in the selected set to items in the database based upon the keyword's ranking and defined relationships wherein a keyword with the highest rank with respect to a particular item is designated as most relevant to the particular item.

38. The computer readable medium of claim 37 wherein the computer executable instructions thereon for automatically determining a relevancy of the keywords with respect to how many users use the keywords to search the database comprise computer executable instructions for:
periodically automatically analyzing all new user-searched keywords; and
automatically designating as highly user-relevant a subset of the new user-searched keywords based on a number of times the subset of new user-searched keywords are being used over a specified amount.

39. The computer readable medium of claim 37 wherein the computer executable instructions thereon for automatically determining a relevancy of the selected set of keywords with respect to search results obtained using the selected set of keywords comprise computer executable instructions for:
automatically searching the database using the selected set of keywords thereby producing search results; and
automatically designating a subset of the selected set of keywords as highly database-relevant based on a number the search results containing the subset of keywords being over a specified amount.

40. The computer readable medium of claim 37 wherein the computer executable instructions thereon for automatically defining relationships between keywords comprise computer executable instructions for:
storing in a keywords database keywords that are determined both highly user-relevant and highly database-relevant based on the automatically determining the relevancy of the keywords with respect to how many users use the keywords to search the database, the automatically selecting a set of keywords based upon the determination of relevancy, and the automatically determining a relevancy of the selected set of keywords with respect to search results obtained using the selected set of keywords;
for each pair of keywords in the keywords database with an IDF assigned greater than zero, automatically determining a number of items in the database containing a first keyword in the pair of keywords (designated herein as Na), automatically determining a number of items in the database containing a second keyword in the keyword pair (designated herein as Nb), automatically determining a number of items in the database containing both keywords in the pair of keywords (designated herein as Nab), automatically calculating a coefficient (designated herein COEF) of the pair of keywords according to the following formula: COEF=Nab/(Na+Nb−Nab), automatically assigning a rank of the second keyword for the first keyword in the pair of keywords according to the following formula: rank=COEF*IDF of keyword, and automatically recording the assigned rank of the second keyword for the first keyword in the pair thereby defining a relationship between the first keyword and second keyword; and
automatically sorting each keyword in the keywords database by the said recorded assigned rank of the keyword with respect to each other keyword in the keywords database;

41. The computer readable medium of claim 37, further comprising computer executable instructions thereon for automatically generating at least one web page as a result of at least one of the keywords being used to search the database and based on the previous associating of the keywords in the selected set to items in the database.

42. The computer readable medium of claim 41, further comprising computer executable instructions thereon for automatically generating a Uniform Resource Locator (URL) from a previous URL of the generated web page, said previous URL having at least one parameter with a value of the at least one of the keywords being used to search the database, said automatically generated URL generated by computer executable instructions for:
automatically defining a position of a possible URL parameter and existence of the possible URL parameter in the generated URL using a number within the generated URL representing a position of said possible URL parameter and existence of said possible URL parameter based on the previous URL; and
automatically generating a URL containing the number as the generated URL.

43. The computer readable medium of claim 42, further comprising computer executable instructions thereon for:
automatically optimizing for search engines the at least one web page generated by automatically displaying in the at least one web page at least one relevant item from the database as determined by the at least one of the keywords being used to search the database and the previous associating of the keywords in the selected set to items in the database; and
automatically optimizing for search engines the at least one web page generated by displaying at least one link within the at least one web page based on relationships of the at least one of the keywords being used to search the database as defined in the defined keyword relationships.

44. A computer readable medium having computer executable instructions thereon for automatically generating a Uniform Resource Locator (URL) from a previous URL, said computer executable instructions thereon comprising computer executable instructions for:
automatically defining a position of a possible URL parameter and existence of the possible URL parameter in the URL using a number within the URL representing a position of said possible URL parameter and existence of said possible URL parameter based on the previous URL; and
automatically generating the URL containing the number.

45. The computer readable medium of claim 44 wherein an order of digits of the number is generated by an order of predefined URL parameters.

46. The computer readable medium of claim 45 wherein the computer executable instructions thereon for automatically defining a position of a possible URL parameter in the URL and existence of the possible URL parameter in the URL comprise computer executable instructions for:
automatically correlating each digit of a binary number with a position of a possible parameter within a previous URL; and
automatically assigning a digit of the number a value of 1 if a parameter exists within the previous URL corresponding to a parameter position correlated to the digit; and
automatically assigning a digit of the number a value of 0 if a parameter does not exist within the previous URL corresponding to a parameter position correlated to the digit.

47. The computer readable medium of claim 46 further comprising computer executable instructions thereon for automatically converting the number into a base-32 number.

48. The computer readable medium of clam 47 further comprising computer executable instructions thereon for adding an additional predefined URL parameter to the generated URL, said adding an additional predefined URL parameter comprising adding the additional predefined URL parameter to the predefined URL parameters by correlating a binary digit to the left of the binary number to the additional predefined parameter, thereby allowing previous URLs generated using the predefined URL parameters to remain the same.

49. The computer readable medium of claim 35 further comprising computer executable instructions thereon for automatically generating the URL containing the number, wherein the URL is formatted such that the number in the URL is followed by URL parameters whose types are Boolean or are one-character in length are connected and separated with the number by a dash.

50. The computer readable medium of claim 49 further comprising computer executable instructions thereon for automatically generating the URL containing the number wherein the URL is formatted such that the number in the URL is preceded by parameters whose type is String and are separated by slashes.

51. The computer readable medium of claim 35 further comprising computer executable instructions thereon for automatically parsing the generated URL according to the order of digits of the number being generated by an order of predefined URL parameters.
